(19) United States
(12) Patent Application Publication
(10) Pub. No.: US 2024/0144386 A1
(43) Pub. Date: May 2, 2024

(54) METHOD, APPARATUS FOR CREATING AN ENHANCED DATABASE STRUCTURE FOR MORE EFFICIENT AUTOMATED ACCOUNTING OPERATIONS

(71) Applicant: Forest Systems, Inc., Mountain View, CA (US)

(72) Inventors: C. Edward Van Deman, Mountain View, CA (US); Daniel Serrano, Mountain View, CA (US); David Campbell, Mountain View, CA (US); John Van Deman, Mountain View, CA (US)

(21) Appl. No.: 17/978,253

(22) Filed: Nov. 1, 2022

(51) Int. Cl. G06Q 40/00; G06F 16/21

(52) U.S. Cl. CPC G06Q 40/123; G06F 16/213

(57) ABSTRACT

A system and method for enhancing a database to thereby determine asset basis in a computerized accounting system, the method includes receiving basic transaction information relating to an asset, the basis transaction information including Real Date, As of Date, Journal ID, Payee ID, and Transaction ID, receiving transaction type information indicating at least one transaction type selected from Return of Capital, Short Sale, Close Short Sale, Transfer Out, Transfer In, Bought, Tax Basis Adjustment, Tax and Cost Basis Adjustment, and/or Sold, receiving additional transaction specific data, the transaction specific data being defined by the transaction type based on at least one rule, building a data matrix of required values for determining basis of the asset based on the additional transaction specific data, the transaction type information, and the basic transaction information, and determining at least one of a market value basis, a cost basis, and a tax basis for the asset based on the transaction type information.

### BACKGROUND

Most automated accounting systems follow principles related to “market value accounting.” These systems use what is referred to as Generally Accepted Accounting Principles (GAAP) which requires that many assets be shown with account balances equal to the market value of the assets. GAAP supports cash basis accounting or accrual basis accounting. Double entries (debit and credit) are required for each transaction. It is well accepted that following GAAP yields information from the accounting system that is meaningful to the user of the financial statements.

Despite the widely accepted approach to using market value accounting, there is another basis for accounting, known as “tax basis accounting.” Tax basis accounting generally is used only for the purpose of reporting taxable income tax and deductions to determine the tax liability of the taxpayer. For taxpayers such as High Net Worth Individuals (HNWI), both methods of accounting, GAAP and tax basis accounting, are important. However, conducting both methods of accounting at the same time in the same system has long been a tremendous challenge for the accounting profession. Current accounting database models do not permit both methods of accounting to be accomplished with the same records. The accounting industry has long struggled to find a way to do one form of accounting and then modify the records to also report on the other form of accounting. This has required keeping two sets of accounting records in one system.

To understand the limitations of prior art accounting databases, it is important to understand the essence of tax basis accounting. IRS Topic No. 703 Basis of Assets, provides the definition of “tax basis.” The tax basis in an asset is generally the amount of capital investment in the asset for tax purposes. The tax basis is applied to determine depreciation, amortization, depletion, casualty losses, and any gain or loss on the sale, exchange, or other disposition of the asset. In many instances, a party's tax basis of an asset is the cost of the asset (i.e., the value the party paid for the asset in cash, debt obligations, and other property or services). Cost includes sales tax and other expenses connected with the purchase. However, a party's tax basis in many assets isn't determined by the cost to the party. One example is when a person acquires property other than through a purchase (such as a gift or an inheritance). See, IRS Publication 551, Basis of Assets. Further, if a person acquired an asset from an individual who died in 2010, special rules may apply to the calculation of tax basis pursuant to IRS Publication 4895, Tax Treatment of Property Acquired From a Decedent Dying in 2010.

As another example, if a party purchases stocks or bonds, the tax basis is the purchase price plus any additional costs such as commissions and recording or transfer fees. If a party owns stocks or bonds that the party did not purchase, the tax basis may have to be determined in accordance with the fair market value of the stocks and bonds on the date of transfer or the basis of the previous owner. See, IRS Publication 550, Investment Income and Expenses.

Before calculating gain or loss on a sale, exchange, or other disposition of an asset, or before calculating allowable depreciation, the adjusted basis in the asset must be determined. Certain events that occur during the period of ownership may increase or decrease the tax basis, resulting in an “adjusted basis.” Tax basis is increased by items such as the cost of improvements that add to the value of the asset, and decreased by items such as allowable depreciation and insurance reimbursements for casualty and theft losses. Accordingly, tax basis can vary significantly from cost basis.

### SUMMARY OF THE INVENTION

Disclosed implementations include creation of a database that permits both GAAP and tax basis accounting to be accomplished using a single set of records without requiring duplicate work that becomes cost prohibitive. The disclosed implementations Allow the user to make Tax Basis Adjusting Entries that affect only the Tax Basis reported balances and have no effect on the Market Value Basis Entries. The disclosed implementations further exclude certain entries that are recorded in the Market Value Basis accounting system. The database of the disclosed implementations thus allows a computerized accounting system to operate more efficiently.

A first aspect of the invention is A method for enhancing a database to thereby determine asset basis in a computerized accounting system, the method comprising: receiving basic transaction information relating to an asset, the basis transaction information including Real Date, As of Date, Journal ID, Payee ID, and Transaction ID; receiving transaction type information indicating at least one transaction type selected from Return of Capital, Short Sale, Close Short Sale, Transfer Out, Transfer In, Bought, Tax Basis Adjustment, Tax and Cost Basis Adjustment, and/or Sold; receiving additional transaction specific data, the transaction specific data being defined by the transaction type based on at least one rule; building a data matrix of required values for determining basis of the asset based on the additional transaction specific data, the transaction type information, and the basic transaction information; and determining at least one of a market value basis, a cost basis, and a tax basis for the asset based on the transaction type information.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the appended drawings various illustrative implementations. It should be understood, however, that the invention is not limited to the precise arrangements and instrumentalities shown. In the drawings:

FIG. 1 is a flowchart of a method for creating a database in accordance with disclosed implementations;

FIG. 2 is a block diagram of a computing architecture in accordance with disclosed implementations.

FIG. 3 is a user interface in accordance with disclosed implementations.

FIG. 4 is a user interface in accordance with disclosed implementations.

FIG. 5 is a user interface in accordance with disclosed implementations.

### DETAILED DESCRIPTION

The database model of the disclosed implementations provides a functioning accounting system that permits tax basis accounting and GAAP to be accomplished using the same data records, thereby increasing efficiency of operation of a computerized accounting system. The disclosed implementations include a novel user interface (UI), calculation methodology, reporting methodology and data model/structure.

Creating this user interface is challenging because it must present the concepts that a person with limited accounting knowledge can understand. The User Interface includes screens to record the following elements of a Tax Basis Adjustment transaction:
Date
Transaction Type
Accounts affected by the transaction
Amount of the transaction
User options for how to handle key aspects of recording a transaction

The transaction types are represented by codes that are used to control how the transaction is processed in the system as it relates to the tax basis accounting or market value accounting in accordance with GAAP. The calculations and display include results when it is necessary to allocate a single amount across multiple accounts for adjusting the tax basis. The UI enables the user to override the default options and specify user defined accounts to be used to record the other side of the double entry that the system must create. The user interface is described in greater detail below.

The calculation methodology of the disclosed implementations achieves the above objectives by:
Converting a single-sided transaction as entered by the user into a double-sided entry required by the accounting system;
Setting default account designations so the user does not have to understand and decide how to record the other side of the double entry; and
Allowing the user to override the default account and set a custom account to be used for the offsetting part of the entity.

The calculation methodology is also described in greater detail below.

The novel data model of the disclosed implementations includes:
a transaction entry file;
an account balance file; and
a user options file.

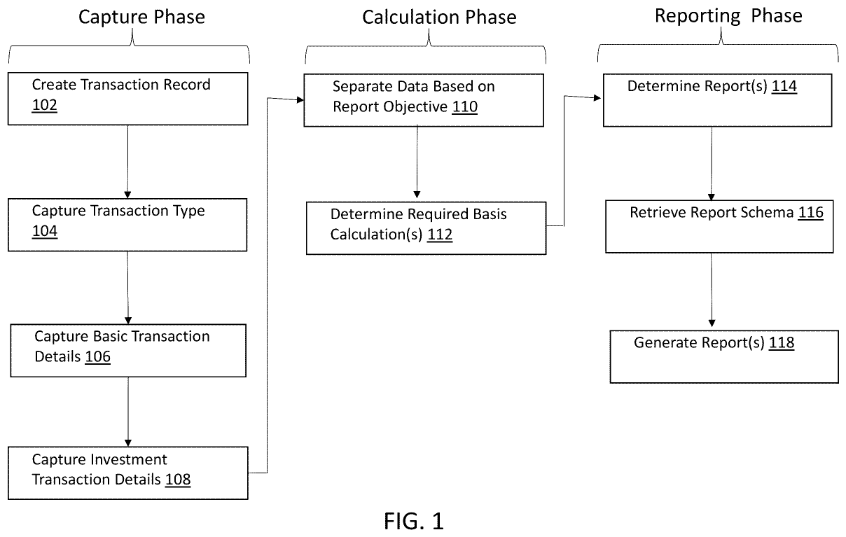

The data model permits a calculation methodology that allows a computerized accounting system to operate with reduced computing resources and thus more efficiently. The data model and calculation methodology are tightly integrated and thus are described in combination below. FIG. 1 illustrates a computer-implemented methodology in accordance with disclosed implementations. The methodology of preferred implementations can be divided into three distinct phases where each has its own objectives:
Data Collection
Calculation
Reporting

At step 102, data is collected to build the basic transaction record. The table below illustrates an example of the structure of the data record.

A. Transaction Table

| Field Name | Description |
|---|---|
| Real Date | Date the transaction was first entered into the |
| | accounting system |
| As Of Date | Date the transaction actually occurred. It can be in |
| | the past if the user is catching up on record keeping. |
| Check Num | Number associated with checks printed from the |
| | system. |
| Print Status | Identifies whether a check transactions is to be |
| | printed or already printed. |
| Journal ID | Identifies the journal in which the transaction was |
| | entered in. |
| Payee ID | The name of the payee/payor associated with a the |
| | transaction. |
| IC Transaction ID | Identifier for transactions between entities. |
| Update Date | The date the transaction was last updated. |
| Updated By | Identifies person who entered the transaction |
| Calculated | Date determined to be the effective date of the |
| Real Date | transaction for accounting purposes. This is often |
| | different from the As of Date and the Real Date |
| Investment/ | See Table B. |
| Transaction | |
| Type Code | |

At step 104, the transaction type is captured through the UI. Once the system has captured data to start the basic transaction, it then needs to know the type of the transaction selected from the Investment Transaction Types in the table below. As described below, the investment transaction type will be used to determine how to process the data it has received and what additional information needs to be obtained to complete this particular transaction.

B. Transaction Investment Type Table

| | | | Sort |
|---|---|---|---|
| Code | Code | Description | Order |
| 1 | Return Of Capital | Proceeds are not a gain but payback of | 3 |
| | | the principal originally invested | |
| 2 | Short Sale | Used to short sell an asset. Captures the | 4 |
| | | amount paid as the cost and tax basis. | |
| 3 | Close Short Sale | Uses the Tax basis and proceeds to | 5 |
| | | calculate capital gain and losses. | |
| | | Reduces cost and tax basis in proportion | |
| | | to the quantity being sold. | |
| 4 | Transfer Out | Indicate transfer of funds out of the | 6 |
| | | portfolio. Not an investment transaction. | |
| | | No tax ramifications. | |
| 5 | Transfer In | Indicate transfer of funds into the | 7 |
| | | portfolio. Not an investment transaction. | |
| | | No tax ramifications. | |
| 7 | Bought | Used to purchase an asset. Captures the | 1 |
| | | amount paid as the cost and tax basis. | |
| 8 | Tax Basis | Adjusts the tax basis of an asset. | 8 |
| | Adjustment | | |
| 9 | Tax and | Adjusts both the tax basis and cost basis | 9 |
| | Cost Basis | of an asset. | |
| | Adjustment | | |
| 14 | Sold | Uses the Tax basis and proceeds to | 2 |
| | | calculate capital gain and losses. | |
| | | Reduces cost and tax basis in proportion | |
| | | to the quantity being sold. | |

Note that Transaction Types 8 and 9 are very different from the other Transaction Types because they affect different fields in the transaction record. This is where the system starts to determine that this transaction is to include data to account for an adjustment in the Tax or Cost basis of an asset.

At step 106, basic transaction details are collected in accordance with the data structure set forth below and based on the Transaction Type. The basic transaction details are stored as a distribution file.

A. Distribution File

Field Name

| | |
|---|---|
| Transaction Table ID | Identifies the transactions the |
| | distributions are linked to. |
| Sort Order | The order of each distribution in the |
| | transaction. |
| Account ID | Identifies the account used in the |
| | distribution. |
| Memo | Memo details. |
| Credit | Amount if it is crediting distributing |
| | account. |
| Debit | Amount if it is debiting the distributing |
| | account. |
| Currency Code | Currency of the account in the |
| | distribution. |
| Distribution Status Code | Identifies if the transaction is cleared on |
| | the distributing account. |
| Update Date | The last date the details were updated. |
| Updated By | The last user to update the details. |

At step 108, capital investment transaction details are captured through the UI. If the system determines this is an investment transaction, it starts to collect, through the UI, additional information it will need to handle the transaction properly in accordance with the data structure set forth below.

A. Transaction Investment Detail

| Field | Description |
|---|---|
| Distribution ID | The identifier for a specific set of details. |
| Trade Date | The date the asset was sold or bought. |
| Quantity | Quantity sold or bought. |
| TaxBasis | This amount is use for both tax basis and |
| | cost basis. |
| Currency Code | Currency of the transaction |
| Investment ID | A unique identifier |
| Update Date | The last date the details were updated. |
| Updated By | The last user to update the details. |
| Tax or Cost Basis Only | Only used with transaction types #8 or |
| | future possible transaction for cost basis |
| | only |

When the methodology has reached this point, the data model has enabled it to collect the information it needs for the type of transactions the user wants to record, without requiring the user to enter data that the system does not need for the type of transaction the user has to enter. The methodology can now proceed to the calculation phase. At step 110, the system builds a data matrix for all the required values given the collected transaction data. This means the system has to take data from elements that were:
Previously recorded,
Entered in the input screen recently, and
Calculated based on the transaction type of the various entries.
   The complete data matrix is required before the system can move to the next phase.

Additionally, the system separates data between the different report objectives: Market value; Tax basis; and Cost basis. At step 112, the required basis calculation(s) is determined. The Transaction Type described above is applied to the following criteria to determine the required basis calculations for the current transaction.

| | | Market | Cost | Tax |
|---|---|---|---|---|
| Code | Description | Value | Basis | Basis |
| 0 | No investment code | Yes | No | No |
| 1 | Return Of Capital | Yes | Yes | Yes |
| 2 | Short Sale | Yes | Yes | Yes |
| 3 | Close Short Sale | Yes | Yes | Yes |
| 4 | Transfer Out | Yes | Yes | Yes |
| 5 | Transfer In | Yes | Yes | Yes |
| 7 | Bought | Yes | Yes | Yes |
| 8 | Tax Basis Adjustment | No | No | Yes |
| 9 | Tax and Cost Basis | No | Yes | Yes |
| | Adjustment | | | |
| 14 | Sold | Yes | Yes | Yes |

Now the methodology proceeds to the reporting phase. At step 114, the various reports requested by the user that contain the critical data are determined. At step 116, one or more schemas corresponding to the requested reports are retrieved. At step 118, the reports are generated based on the collected data and the schema(s). The reports can include reports which fall under the following report groups:
Balance Sheets
Investment Reports
Tax Reports
Transaction Listings

Each of these report groups has its own special purpose and schema. The disclosed implementations are able to use the data model that was created in the previous phases to provide information exactly as requested by the user.

A balance sheet report focuses on comprehensive values for a specific point in time and across the entire net worth set of accounts. These values are calculated from the captured transactions to show values for the point in time of interest to the user for this report. Other values on the report are calculated from these core values. An example of a balance sheet schema is shown below.

Balance Sheet Schema

Account Name
Quantity
Market Value Balance
Tax Basis Amount

An investment sheet focuses on values for specific types of accounts for a point in time. Some of these values are calculated from transaction data in the database. Others can be taken directly from data captured and stored in the database. An example of an investment sheet schema is shown below.

Investment Sheet Schema

Account Name
Quantity
Market Value Balance
Cost Basis Amount

Tax Reports-Schedule D is critical for reporting tax basis information taken from the data model described above. An example of a tax report schema is shown below.

Tax Reports - Schedule D Data Model

Account Name
Quantity
Acquisition Date
Sale Date
Proceeds from Sale
Tax Basis Amount

An example of transactions listing schema is shown below.

Transaction Listings Data Model

Date
Payees
Account Name
Transaction Amount

It is important that the terminology on reports be as accurate as possible for the situation being reported. This is especially true for distinguishing between Individual and Partnership entities. Disclosed implementations analyze the equity section of a Chart of Accounts to detect whether the report being generated is for an Individual or a Partnership. The system determines if the entity is an Individual or a Partnership based on the accounts in the Equity section of the Chart of Accounts. The terminology is automatically adjusted in the grand total label to properly match the entity type.

When there are no Equity accounts displayed on a Balance Sheet report, the system assumes the entity is an Individual. In this case, the system default label is Total Liabilities and Net Worth. When Equity accounts are displayed on a Balance Sheet report, the system assumes the entity is a Partnership or Corporation. The system default label is Total Liabilities and Equity. The other labels in the Net Worth section are not necessarily automatically changed. Those labels can be changed in the Entity Settings UI discussed below.

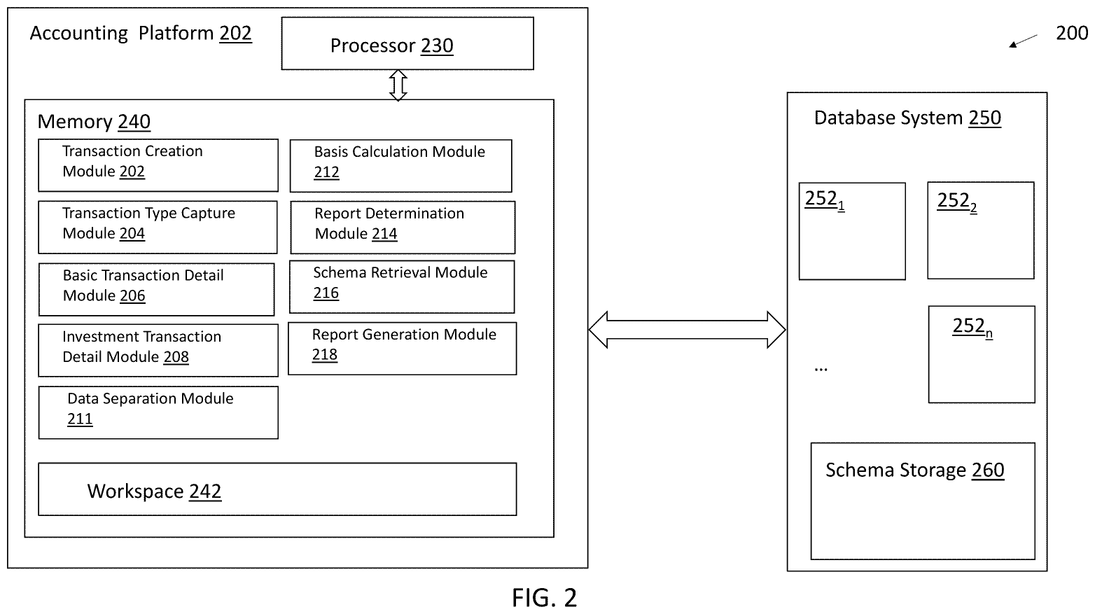

FIG. 2 illustrates a computing architecture of system 200 in accordance with disclosed implementations. System 200 includes database system 250 for storing data records 252₁ . . . 252ₙ. The various schemas defined herein are stored in schema storage 160 of database system 250. The data capture and processing described herein are accomplished by accounting platform 202 which includes computer processor 230 and memory 240. Memory 240 stores instructions that can be executed by processor 230 to cause processor 230 to accomplish the functions disclosed herein. The instructions are illustrated as corresponding to functional modules. Workspace 242 is used by processor 230 for temporary storage required for processing.

Transaction creation module 202 causes processor 230 to accomplish the function of step 102 of FIG. 1. Transaction type capture module 204 causes processor 230 to accomplish the function of step 204 of FIG. 1. Basis transaction detail module 206 causes processor 230 to accomplish the function of step 106 of FIG. 1. Investment transaction detail module 208 causes processor 230 to accomplish the function of step 108 of FIG. 1. Data separation module 210 causes processor 230 to accomplish the function of step 110 of FIG. 1. Basis calculation module 212 causes processor 230 to accomplish the function of step 112 of FIG. 1. Report determination module 214 causes processor 230 to accomplish the function of step 114 of FIG. 1. Schema retrieval module 216 causes processor 230 to accomplish the function of step 116 of FIG. 1. Report generation module 218 causes processor 230 to accomplish the function of step 118 of FIG. 1.

As noted above, data can be input into the system by a user through a UI. Alternatively, data can be imported into the system through a file or received through an application programming interface (API) in a conventional manner.

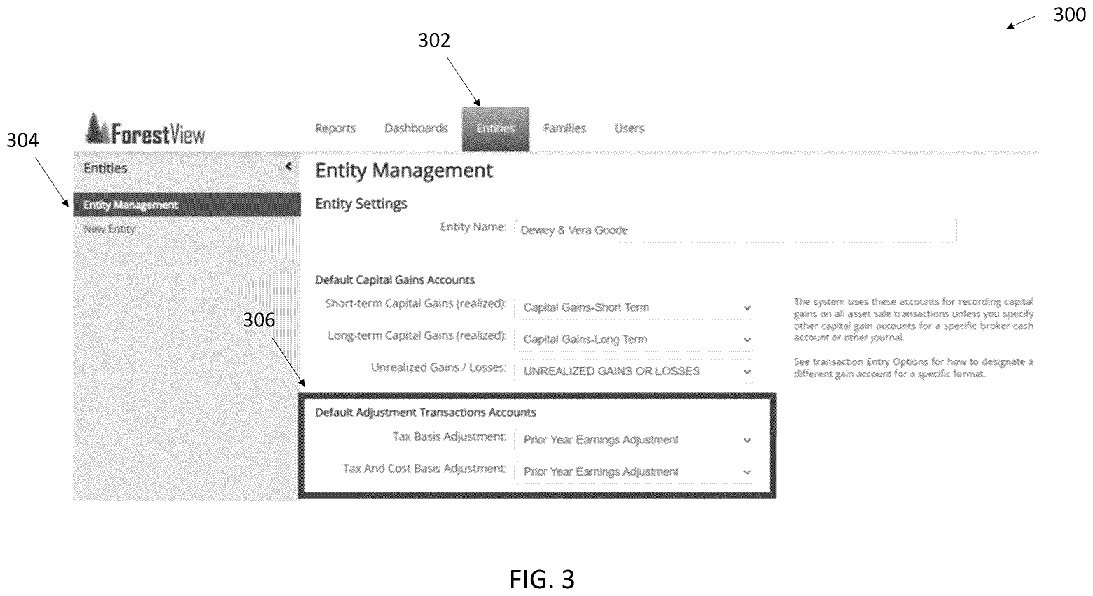

More detailed examples of the UI discussed above will now be described. FIG. 3 illustrates an example of a UI 300 for assigning default accounts in disclosed implementations. A user selects Entities tab 302, then selects Entity Management at 304. A user can then select an account for each transaction type in default adjustments transaction at 306.

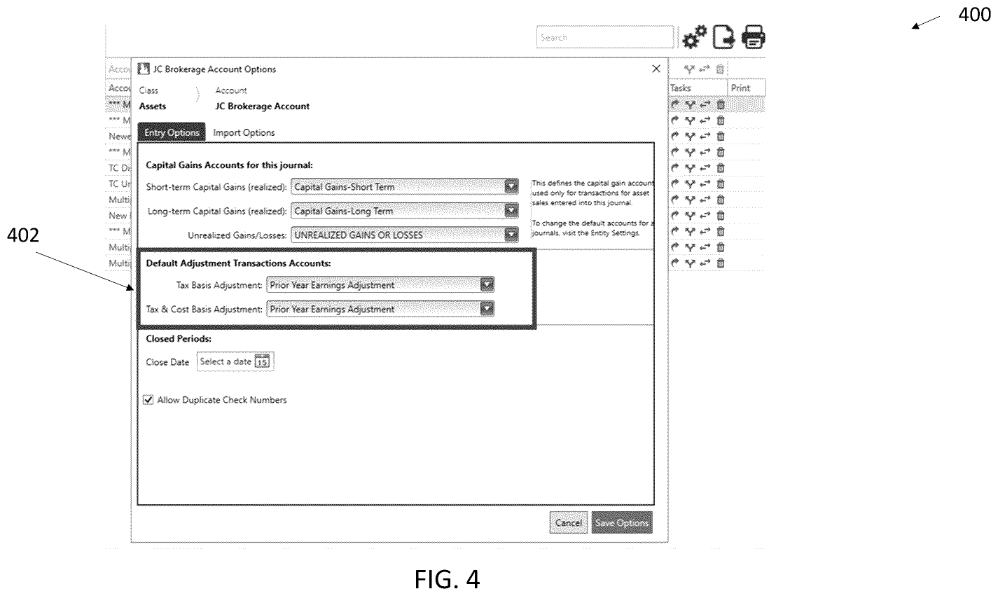

As shown in FIG. 4, journal specific accounts can be assigned at 402 of UI 400 when a user wants to have separate accounts for each Journal. The system always uses these account selections when they are present.

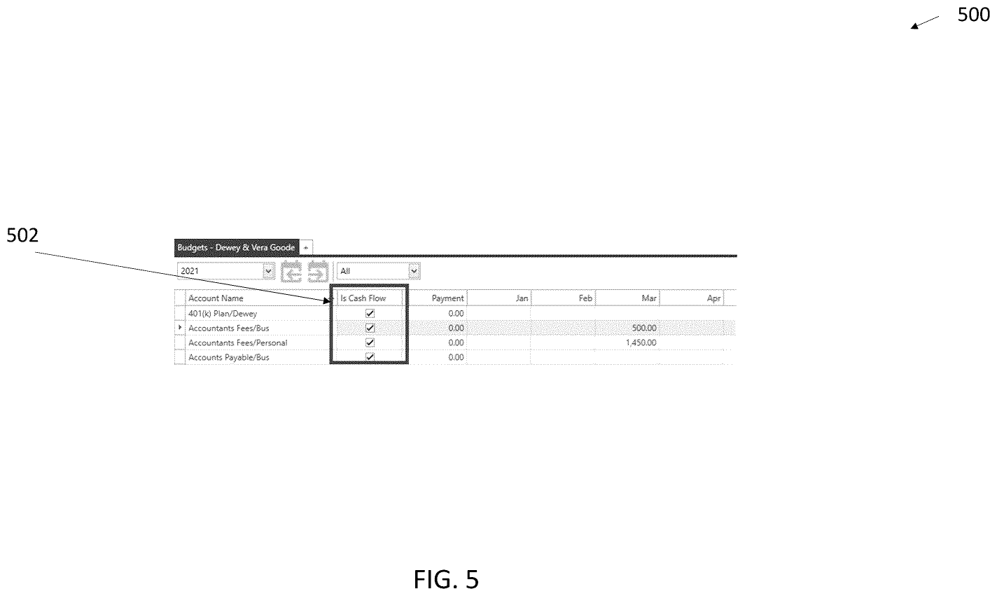

Cash flow reports are the most meaningful when users can control whether accounts are considered cash flow items or non-cash flow for purposes of being included in the calculation of Cash Flow on the various reports. For example, expenses paid through a credit card technically would not appear on Cash Flow reports since they only affect a liability account and not a cash balance. Technically, the cash flow only occurs when a credit card payment is made. However, a user may want to define cash flow differently, include the charges as cash flow items, and make the payment of the credit card bill not a cash flow item. As shown in FIG. 5, UI 500 allows a user to include in cash flow either the individual budgeted expense accounts or a single sum for the credit card payment by selecting the accounts at 502. There are many other situations when a user will want to designate accounts as cashflow items or not.

The disclosed implementations require complex calculations that cannot pragmatically be accomplished without an electronic digital computing platform. Computing systems and/or logic referred to herein can comprise an integrated circuit, a microprocessor, a personal computer, a server, a distributed computing system, a communication device, a network device, or the like, and various combinations of the same. A computing system or logic may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), optical circuits, and/or other devices configured for storing analog or digital information, such as in a database. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The logic discussed herein, referred to as “modules”, may include hardware, firmware and/or software stored on a non-transient computer readable medium. This logic may be implemented in an electronic device to produce a special purpose computing system. The systems discussed herein optionally include a microprocessor configured to execute any combination of the logic discussed herein. The methods discussed herein optionally include execution of the logic by said microprocessor. The disclosed implementations are described as including various “modules”, “engines”, and “logic”, all of which refer to executable code and a computer hardware processor for executing the code to accomplish the described functionality. The Data Storage may be distributed throughout several computing devices.

It will be appreciated by those skilled in the art that changes could be made to the implementations described above without departing from the broad inventive concept thereof. It is understood, therefore, that this invention is not limited to the particular implementations disclosed, but it is intended to cover modifications within the spirit and scope of the present invention as defined by the appended claims.

What is claimed:

1. A method for enhancing a database to thereby determine asset basis in a computerized accounting system, the method comprising:
receiving basic transaction information relating to an asset, the basis transaction information including Real Date, As of Date, Journal ID, Payee ID, and Transaction ID;
receiving transaction type information indicating at least one transaction type selected from Return of Capital, Short Sale, Close Short Sale, Transfer Out, Transfer In, Bought, Tax Basis Adjustment, Tax and Cost Basis Adjustment, and/or Sold;
receiving additional transaction specific data, the transaction specific data being defined by the transaction type based on at least one rule;
building a data matrix of required values for determining basis of the asset based on the additional transaction specific data, the transaction type information, and the basic transaction information; and
determining at least one of a market value basis, a cost basis, and a tax basis for the asset based on the transaction type information.

2. The method of claim 1, further comprising retrieving at least one report schemas based on the transact type and generating a report corresponding to each retrieved schema and based on the basic transaction data and the transaction specific data.

3. The method of claim 1, wherein the steps of receiving basis transaction information, receiving transaction type information, and receiving additional transaction specific data comprise presenting a user interface and receiving data from a user through the user interface.

4. The method of claim 1, wherein the basic transaction information includes data cvalues for the following data fields:
Real Date, As Of Date, Check Num, Print Status, Journal ID, Payee ID, IC Transaction ID, Update Date, Updated By, and Calculated Real Date.

5. The method of claim 1, wherein the additional transaction specific data includes data values for the following data fields:
Transaction Table ID, Sort Order, Account ID, Credit, Debit, Currency Code, Distribution Status Code, Update Date, and Updated By.

6. The method of claim 1, wherein the transaction type is Investment and the additional transaction specific data includes data values for the following data fields:
Distribution ID, Trade Date, Quantity, TaxBasis, Currency Code, Investment ID, Update Date, Updated By, and Tax or Cost Basis Only.

7. A computer system enhancing a database and determining asset basis in a computerized accounting system, the system comprising:
at least one computer processor; and
at least one memory device having instructions stored therein which, when executed by the at least one computer processor, cause the at least one computer processor to carry out the method of:
receiving basic transaction information relating to an asset, the basis transaction information including Real Date, As of Date, Journal ID, Payee ID, and Transaction ID;
receiving transaction type information indicating at least one transaction type selected from Return of Capital, Short Sale, Close Short Sale, Transfer Out, Transfer In, Bought, Tax Basis Adjustment, Tax and Cost Basis Adjustment, and/or Sold;
receiving additional transaction specific data, the transaction specific data being defined by the transaction type based on at least one rule;
building a data matrix of required values for determining basis of the asset based on the additional transaction specific data, the transaction type information, and the basic transaction information; and
determining at least one of a market value basis, a cost basis, and a tax basis for the asset based on the transaction type information.

8. The system of claim 7, wherein the method further comprises retrieving at least one report schemas based on the transact type and generating a report corresponding to each retrieved schema and based on the basic transaction data and the transaction specific data.

9. The system of claim 7, wherein the steps of receiving basis transaction information, receiving transaction type information, and receiving additional transaction specific data comprise presenting a user interface and receiving data from a user through the user interface.

10. The system of claim 7, wherein the basic transaction information includes data cvalues for the following data fields:
Real Date, As Of Date, Check Num, Print Status, Journal ID, Payee ID, IC Transaction ID, Update Date, Updated By, and Calculated Real Date.

11. The system of claim 7, wherein the additional transaction specific data includes data values for the following data fields:
Transaction Table ID, Sort Order, Account ID, Credit, Debit, Currency Code, Distribution Status Code, Update Date, and Updated By.

12. The system of claim 7, wherein the transaction type is Investment and the additional transaction specific data includes data values for the following data fields:
Distribution ID, Trade Date, Quantity, TaxBasis, Currency Code, Investment ID, Update Date, Updated By, and Tax or Cost Basis Only.
